(19) United States
(12) Patent Application Publication
(10) Pub. No.: US 2014/0304589 A1
(43) Pub. Date: Oct. 9, 2014

(54) FEEDBACK IN HUMAN-MACHINE INTERACTIVE OPERATION

(71) Applicant: Alibaba Group Holding Limited, Grand Cayman (KY)

(72) Inventor: Xiaohan Mei, Hangzhou (CN)

(73) Assignee: Alibaba Group Holding Limited, Grand Cayman (KY)

(21) Appl. No.: 14/242,556

(22) Filed: Apr. 1, 2014

(30) Foreign Application Priority Data
Apr. 3, 2013 (CN) 201310116416.5

(51) Int. Cl. G06F 17/22

(52) U.S. Cl. CPC G06F 17/2247
USPC 715/234

(57) ABSTRACT

One or more feedback type parameters and page construction data of one or more feedback types that correspond to operations at a page are extracted and pre-stored. One or more feedback pages for real-time operation corresponding to different operations at the page are constructed by using a same feedback page template in accordance with the feedback type parameters and the page construction data of the feedback types that correspond to the operations at the page. One or more selected operation items at a basic operation page are obtained. Their corresponding feedback pages for real-time operation are activated and displayed. The one or more selected operation items and their corresponding feedback areas are reloaded at the feedback pages for real-time operation. The present techniques construct uniform and consistent feedback pages for real-time operation based on different operation feedback types and have good interaction expectation.

### CROSS REFERENCE TO RELATED PATENT APPLICATIONS

This application claims foreign priority to Chinese Patent Application No. 201310116416.5 filed on 3 Apr. 2013, entitled “Method and Apparatus for Feedback in Human-Machine Interactive Operation,” which is hereby incorporated by reference in its entirety.

### TECHNICAL FIELD

The present disclosure is related to the field of human-machine interaction, and more particularly, to a method and an apparatus for feedback in a human-machine interactive operation.

### BACKGROUND

In a handheld device, a display page primarily includes the following types of feedback operations that are based on operation flows of a main task of a user. The types of feedback operations include a feedback for a selecting operation in a form page, a feedback for an inputting operation in the form page, a feedback for an extending operation at a bottom toolbar of a system frame, a feedback for a double confirming operation which may lead to a serious or an irreversible result, such as a deletion, and a feedback for a conventional operation for clicking one item to move to a next page.

However, different feedback operations have their respective page frames and page content definitions, and thus generally have different human-machine interactive interfaces and generate different human-machine interactive feedbacks. For example, different operation feedbacks may appear in different positions in a page, which confuses the user's expectation about the feedback of an operation in a flow sequence of the main task. For example, with respect to a feedback of selection operation at the handheld device, there are a number of selectable items at a dialog box for selection which is usually achieved by means of a spinner control item. When a toolbar at the bottom of the page is clicked, an operation panel will pop up from a center or the bottom of the page in which there is a number of operation items for selection. Another example is feedback of the inputting operation for an input method editor (IME). An IME keyboard will pop up from the bottom of the page when a specific input field on the page is clicked.

Thus, the conventional feedback operations have different methods for displaying the feedbacks. In addition, the conventional techniques lack a corresponding relationship between an operation item, which triggers the feedback operation, and a feedback page. The conventional techniques lack good interactive expectation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present techniques improve diversity of results in the direction technology.

The present disclosure provides a method and an apparatus for feedback in a human-machine interactive operation.

One or more feedback type parameters and page construction data of one or more feedback types that correspond to operations at a page are extracted and pre-stored. One or more feedback pages for real-time operation corresponding to different operations at the page are constructed by using a same feedback page template in accordance with the feedback type parameters and the page construction data of the feedback types that correspond to the operations at the page.

One or more selected operation items at a basic operation page are obtained. Their corresponding feedback pages for real-time operation are activated and displayed. The one or more selected operation items and their corresponding feedback areas are reloaded at the feedback pages for real-time operation.

In an example embodiment of the present disclosure, when the corresponding feedback page for real-time operation is activated and displayed, the feedback page for real-time operation is displayed in an effective display area by reference to the effective display area of a terminal device and a proper operation manner that is suitable for the user to operate at the terminal device.

In an example embodiment of the present disclosure, when the effective area of the terminal device is displayed in a top-down view, the proper operation manner that is suitable for the user to operate at the terminal device may include the following. The corresponding feedback page for real-time operation is displayed by popping up from a bottom of the effective display area to a top of the effective display area.

In an example embodiment of the present disclosure, the basic operation page may include a status bar, a page title/navigating area, a page content area, and a page operation area. The one or more selected operation items are loaded in the page content area of the basic operation page.

In an example embodiment of the present disclosure, when the one or more selected operation items and the corresponding feedback area are reloaded, they are reloaded by loading a mask in the feedback page for real-time operation to indicate a corresponding relationship between the selected operation item and the corresponding feedback area.

In an example embodiment of the present disclosure, the selected operation item may be highlighted in a color adjustment manner. Alternatively, the selected operation item and its corresponding feedback area may have consistent color to indicate the corresponding relationship between the selected operation item and the corresponding feedback area.

In an example embodiment of the present disclosure, when the mask is loaded in the feedback page for real-time operation, a layout of the loaded mask is obtained by determining position information of the selected operation item, the feedback type parameters and the page constructing data of the feedback types that correspond to the operations at the page.

In an example embodiment of the present disclosure, after the layout of the loaded mask is obtained, the mask is divided into different areas in which the selected operation item and the corresponding feedback area of the selected operation item are loaded respectively.

In an example embodiment of the present disclosure, when a space between an area where the feedback area locates in the feedback page for real-time operation and an area where the selected operation item locates in the feedback page for real-time operation is larger than or equal to a predetermined mask space value, the loading process is performed in accordance with an actual area of the feedback area and the selected operation item respectively. Otherwise, the areas of the selected operation item and the corresponding feedback area in the feedback page for real-time operation are re-adjusted in an extending direction from the bottom to the top of the effective display area so that the feedback area is extended in accordance with an actual page size requirement. Thus, such re-adjustment may maintain the space between the area where the selected operation item locates in the feedback page for real-time operation and the area where the corresponding feedback area locates in the feedback page for real-time operation after the re-adjustment as the predetermined mask space value. Alternatively, such re-adjustment may cause the area where the selected operation item locates in the feedback page for real-time operation and the area where the corresponding feedback area locates in the feedback page for real-time operation are directly adjacent to each other.

In an example embodiment of the present disclosure, the feedback type parameters of the feedback types that correspond to the operations at the page may include a definition of a page frame and a definition of a page content. The page constructing data may include a capacity of the page content.

In an example embodiment of the present disclosure, the feedback types that correspond to the operations at the page may include one of the following or any combination thereof: a selecting operation feedback type, an inputting operation feedback type, an extending operation feedback type, and a double confirming operating feedback type.

The present disclosure also provides an apparatus for feedback in a human-machine interactive operation. The apparatus may include an extracting module, a constructing module, and a central processing module.

The extracting module extracts and pre-stores one or more feedback type parameters and page construction data of one or more feedback types that correspond to operations at a page.

The constructing module constructs one or more feedback pages for real-time operation corresponding to different operations at the page by using a same feedback page template in accordance with the feedback type parameters and the page construction data of the feedback types that correspond to the operations at the page.

The central processing module obtains one or more selected operation items at a basic operation page, activates and displays their corresponding feedback pages for real-time operation, and reloads one or more selected operation items and their corresponding feedback areas at the feedback pages for real-time operation.

In an example embodiment of the present disclosure, the apparatus may further include a mask loading module that loads a mask in the feedback page for real-time operation to reload the selection operation item and its corresponding feedback area, determines position information of the selected operation item, feedback type parameters and page constructing data of the feedback types that correspond to the operations at the page, and obtains a layout of the loaded mask.

In an example embodiment of the present disclosure, the mark loading module, after the layout of the loaded mask is obtained, divides the mask into different areas in which the selected operation item and the corresponding feedback area of the selected operation item are loaded respectively.

In an example embodiment of the present disclosure, the central processing module, when the corresponding feedback page for real-time operation is activated and displayed, displays the feedback page for real-time operation in an effective display area by reference to the effective display area of a terminal device and a proper operation manner that is suitable for a user to operate at the terminal device. When the effective area of the terminal device is displayed in a top-down view, the proper operation manner that is suitable for the user to operate at the terminal device may include the following. The corresponding feedback page for real-time operation is displayed by popping up from a bottom of the effective display area to a top of the effective display area.

In an example embodiment of the present disclosure, the central processing module, when a space between an area where the feedback area locates in the feedback page for real-time operation and an area where the selected operation item locates in the feedback page for real-time operation is larger than or equal to a predetermined mask space value, performs the loading process in accordance with an actual area of the feedback area and the selected operation item respectively. Otherwise, the central processing module re-adjusts the areas of the selected operation item and the corresponding feedback area in the feedback page for real-time operation in an extending direction from the bottom to the top of the effective display area so that the feedback area is extended in accordance with an actual page size requirement. Thus, such re-adjustment may maintain the space between the area where the selected operation item locates in the feedback page for real-time operation and the area where the corresponding feedback area locates in the feedback page for real-time operation as the predetermined mask space value after the re-adjustment. Alternatively, such re-adjustment may cause the area where the selected operation item locates in the feedback page for real-time operation and the area where the corresponding feedback area locates in the feedback page for real-time operation directly adjacent to each other.

The present techniques extract and pre-store feedback type parameters and page constructing data of feedback types that correspond to operations at the page, use the same feedback page template, and construct the feedback page for real-time operation corresponding to various operations at the page in accordance with the feedback type parameters and page constructing data of feedback types that correspond to operations at the page respectively. The present techniques construct uniform and consistent feedback pages for real-time operation based on different operation feedback types, and reload the selected operation item and the corresponding feedback area at the feedback page for real-time operation. Therefore, when the user operates an operation item, the present techniques may achieve human-machine interaction based on the current feedback page for real-time operation. The present techniques have good interactive expectation without adjusting to different feedback pages defined by different feedback types and may continuously adjust the interaction behaviors.

### BRIEF DESCRIPTION OF THE DRAWINGS

The FIGs are used to provide illustration of the present disclosure and thus are part of the present disclosure. The illustrative examples and their explanations are used to illustrate the present disclosure and should not be used to limit the present disclosure.

FIG. 1 is a flowchart illustrating an example method for feedback in a human-machine interactive operation according to a first example embodiment of the present disclosure.

FIG. 2 is a schematic diagram illustrating an example basic operation page displayed in a top-down view.

FIG. 3 is a flowchart illustrating an example process that loads a mask according to a second example embodiment of the present disclosure.

FIG. 4 is a schematic diagram illustrating an example basic operation page.

FIG. 5 is a schematic diagram illustrating an example feedback page for real-time operation.

FIG. 6 is a flowchart illustrating an example process that loads the mask according to a third example embodiment of the present disclosure.

FIG. 7 is a schematic diagram illustrating another example feedback page for real-time operation.

FIG. 8 is a diagram illustrating an example apparatus for feedback in a human-machine interactive operation according to a fourth example embodiment of the present disclosure.

FIG. 9 is a diagram illustrating an example apparatus for feedback in a human-machine interactive operation according to a fifth example embodiment of the present disclosure.

### DETAILED DESCRIPTION

The following description describes the present disclosure with reference to the accompanied FIGs and example embodiments to illustrate how the present disclosure applies the technical techniques to resolve technical problems and achieve technical effects and help understand implementation of the present techniques.

The present techniques extract and pre-store feedback type parameters and page constructing data of feedback types that correspond to operations at the page, use the same feedback page template, and construct the feedback page for real-time operation corresponding to various operations at the page in accordance with the feedback type parameters and page constructing data of feedback types that correspond to operations at the page respectively. The present techniques construct a uniform and consistent feedback pages for real-time operation based on different operation feedback types, and reload the selected operation item and the corresponding feedback area at the feedback page for real-time operation. Therefore, when the user operates an operation item, the present techniques may achieve human-machine interaction based on the current feedback page for real-time operation. The present techniques have good interactive expectation without adjusting to different feedback pages defined by different feedback types and may continuously adjust the interaction behaviors.

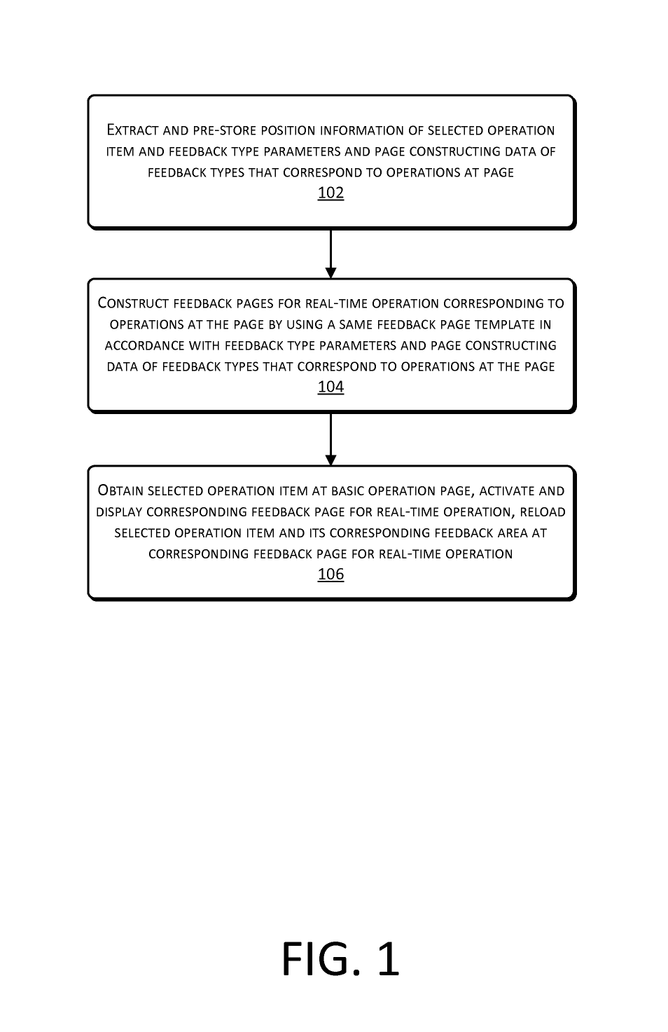

FIG. 1 is a flowchart illustrating an example method for feedback in a human-machine interactive operation according to a first example embodiment of the present disclosure.

At 102, one or more feedback type parameters and page construction data of one or more feedback types that correspond to operations at a page are extracted and pre-stored.

In the example embodiment, the feedback type parameters of the feedback types that correspond to the operations at the page may include, but are not limited to, a definition of a page frame and a definition of a page content. The page constructing data may include a capacity of the page content. The definition of the page frame refers to a layout that the page displays different contents, such as a display position relationship between an operation item and its corresponding sub-operation items. The definition of the page content may indicate a triggering area in the page which is defined in accordance with the position relationship of the operation item and the corresponding sub-operation items. The page constructing data, for example, may be a number of the sub-operation items, a maximum number of acceptable input characters at a content input area, a height of an input method editor (IME) keyboard, etc.

In the example embodiment, the feedback types that correspond to the operations at the page may include one of the following or any combinations thereof: a selecting operation feedback type, an inputting operation feedback type, an extending operation feedback type, and a double confirming operating feedback type.

As described above, the selecting operating feedback type is, for example, when an operation item is activated, to provide a selection option to the user to continue or cancel a current operation. The inputting operation feedback type is, for example, when the user activates an option for the IME, to input contents in the feedback area. The extending operation feedback type is generally processed based on a toolbar at a bottom of a system frame. The double confirming operating feedback type is to determine whether the user finally determines to perform the current selected operation item. Thus, different feedback types have different processes for user feedbacks.

At 104, one or more feedback pages for real-time operation corresponding to different operations at the page are constructed by using a same feedback page template in accordance with the feedback type parameters and the page construction data of the feedback types that correspond to the operations at the page.

At 106, one or more selected operation items at a basic operation page are obtained. Their corresponding feedback pages for real-time operation are activated and displayed. The one or more selected operation items and their corresponding feedback areas are reloaded at the feedback pages for real-time operation.

In the example embodiment, the basic operation page may include, but is not limited to, a status bar, a header that may include a page title/navigating area, a content that may include a page content area, and a footer that may include a page operation area. The selected operation item is loaded in the page content area of the basic operation page. The status bar is mainly to indicate which contents that corresponding to the operation items at the terminal are currently in an operating status. A title, a tab, or a navigation of the page is usually set up at the title/navigating area, whose main technical function is to navigate the page. The page content area refers to an effective display area of the page, such as a triggering area of sub-operation items that correspond to a specific operation item. The page operation area or the footer is a definition area that operates the basic operation page, such as whether to cancel the current page, or return to a previous level page of the current page.

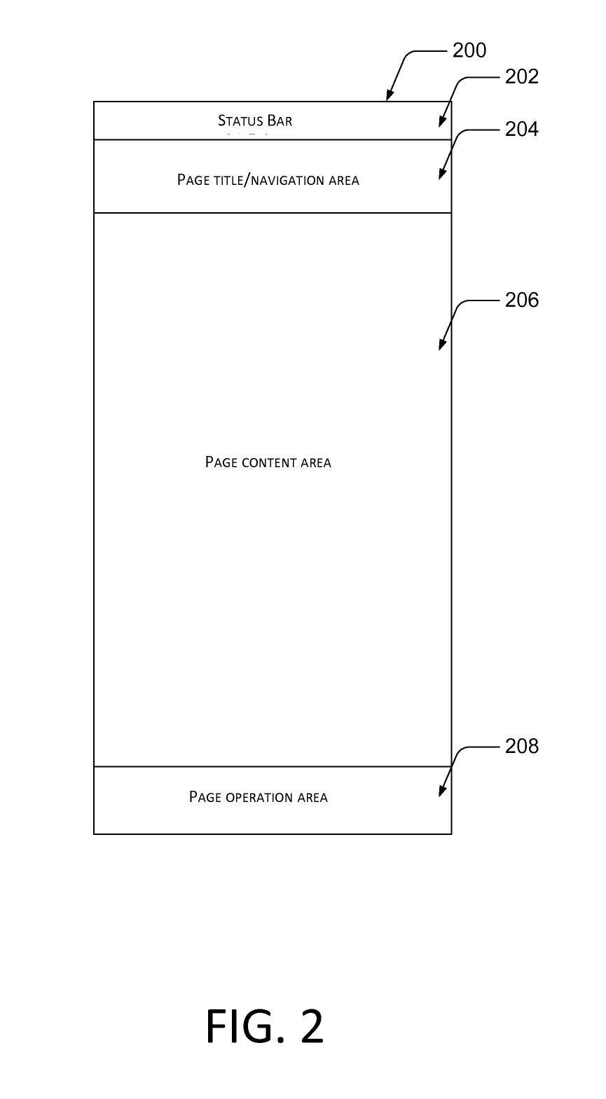

It should be noted that, although the basic operation page may include the status bar, the page title/navigating area, the page content area, and the page operation area, the basic operation page may be defined according to the effective display area when the page is specifically defined. FIG. 2 shows a schematic diagram illustrating an example basic operation page displayed in a top-down view. When a display is presented vertically, from top to bottom, an example basic operation page 200 may be defined as a status bar 202, a page title/navigating area 204, a page content area 206, and a page operation area 208. The page operation area 208 is located at a bottom of the basic operation page 200. When the display is presented horizontally, from left to right, the basic operation page may be defined as the status bar, the page title/navigating area, the page content area, and the page operation area. The page operation area locates at the rightmost of the current basic operation page. Alternatively, from right to left, the basic operation page may be defined as the status bar, the page title/navigating area, the page content area, and the page operation area. The page operation area locates at the leftmost of the current basic operation page. No matter what kinds of definition manner is applied, as long as it provides convenience to the user for operation and improves the convenience of feedbacks, the specific definition manner for the basic operation page is not limited by the present disclosure.

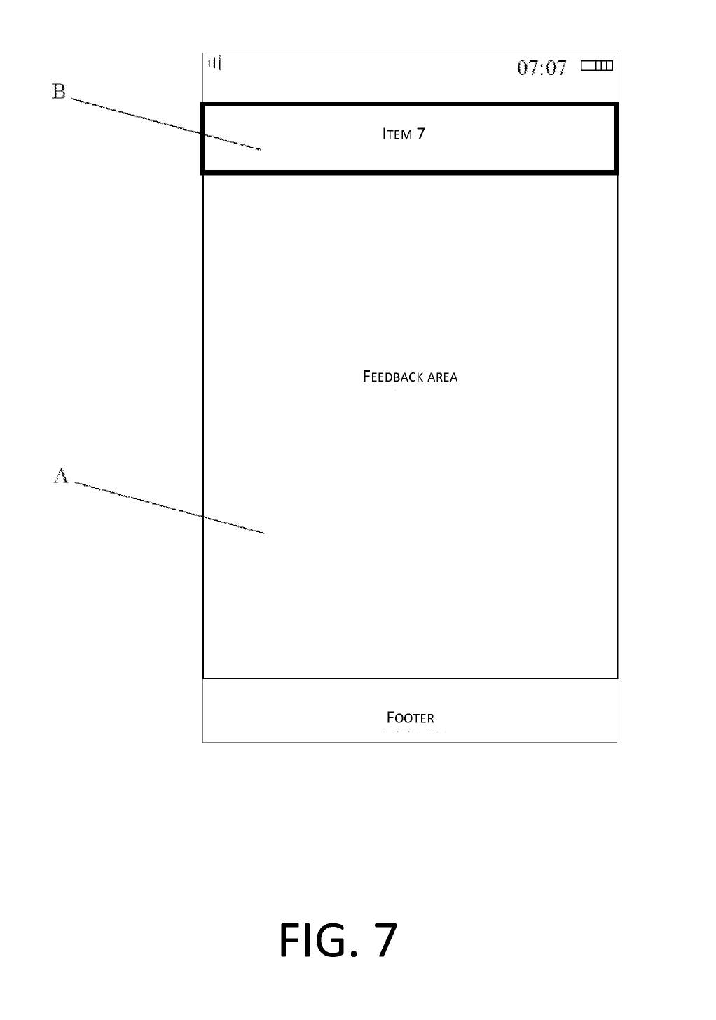

At 106, when the corresponding feedback page for real-time operation is activated and displayed, the feedback page for real-time operation is displayed at the effective display area by reference to the effective display area of the terminal device and a proper operation manner that is suitable for the user to operate at the terminal device. For example, the effective display area is usually small at a mobile phone. As the current mobile phones generally supports switching the screen between horizontal display and vertical display, when the feedback page for real-time operation is generated, the present techniques determine whether a current screen status of the mobile phone is vertical, i.e., displaying in a top-down view, or horizontal, i.e., displaying in a left-right view or right-left view, in order to determine that the generated feedback page for the real-time operation is performed in a manner of top-down view display, left-right view display, or right-left view display. For example, when the effective display area of the terminal device is displayed in the top-down view, the proper operation manner suitable for the user to operate at the terminal device includes displaying the corresponding feedback page for real-time operation by popping up from the bottom of the effective display area to the top of the effective display area. Specifically, when the page is displayed in a top-down view, usually there is a page bottom operation area at the bottom of the operation page. In this case, the proper operation manner suitable for the user to operate the terminal device is to display the corresponding feedback page for real-time operation in a direction from the page operating area at the bottom to the header of the page at the top. The details may refer to FIG. 7 as described below.

In the example embodiment, at 106, when the selected operation item and the corresponding feedback area are reloaded, such process is conducted by loading the mask in the feedback page for real-time operation to highlight the corresponding relationship between the selected operation item and the corresponding feedback area. For example, the selected operation item is highlighted at the feedback page for real-time operation. For another example, an identification or a color change is loaded in the feedback area. For instance, the color of the operation item may be the same as that of the feedback area. It should be noted that the example embodiment only uses the mask loading method to describe enhancing the logical connection between the selected operation item and the feedback operating area. Thus, the present techniques cause the user have certain expectation with respect to the current feedback operation, improve the user experiences, and increase the user's sense of feeling. The present techniques are not limited to the method of loading the mask.

For example, in the following example embodiment, the selected operation item and the corresponding feedback area at the feedback page for real-time operation are directly adjacent to each other. This is also a method to enhance the logical connection between the two. One of ordinary skill in the art may apply any other alternative method without any creative efforts as long as the area of the selected operation item and the corresponding feedback area at the feedback page for real-time operation may be reasonably defined. The details are not described herein. It is noted that the mask is one of the applicable methods.

When the mask is loaded, position information of the selected operation item may be defined at the feedback page for real-time operation. In other words, a triggering area to trigger the operation item is provided to the user at the page. In addition, the feedback type parameters and page construction data of the feedback types corresponding to the operations at the page are defined to determine a layout relationship between the selected operation item and the feedback area at the mask. For example, when a display is presented in a vertical screen manner, the layout of the mask may be defined in a top-down direction. For instance, the triggering area of the selected operation item is above the triggering area of the feedback area. In addition, during the process of defining the layout, the layout of the mask may be re-adjusted according to a size of the feedback area and hence to re-adjust the position relationship between the selected operation item and the corresponding feedback area. The details are not described herein and may be referenced to the following example embodiment.

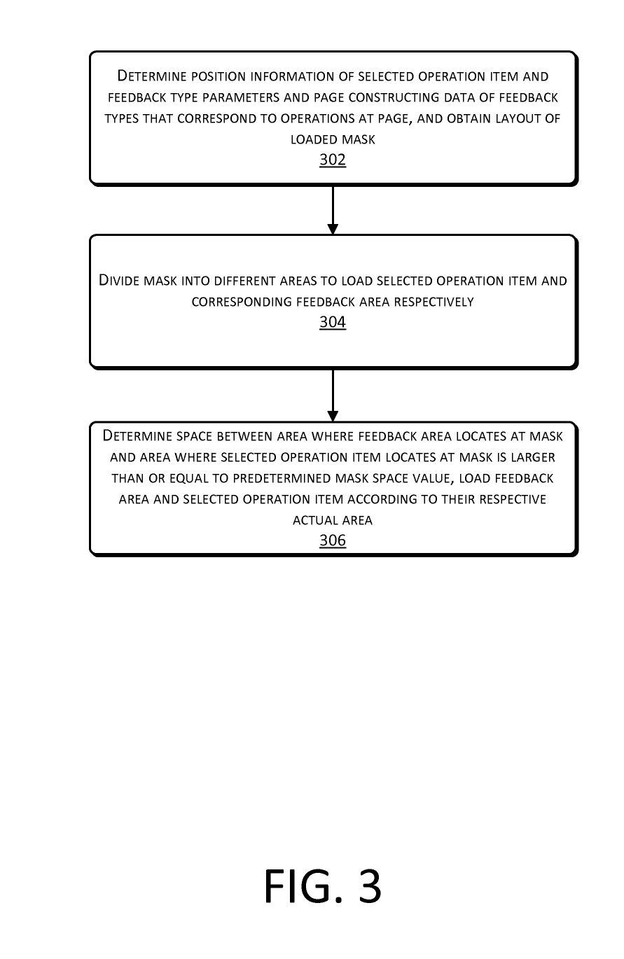

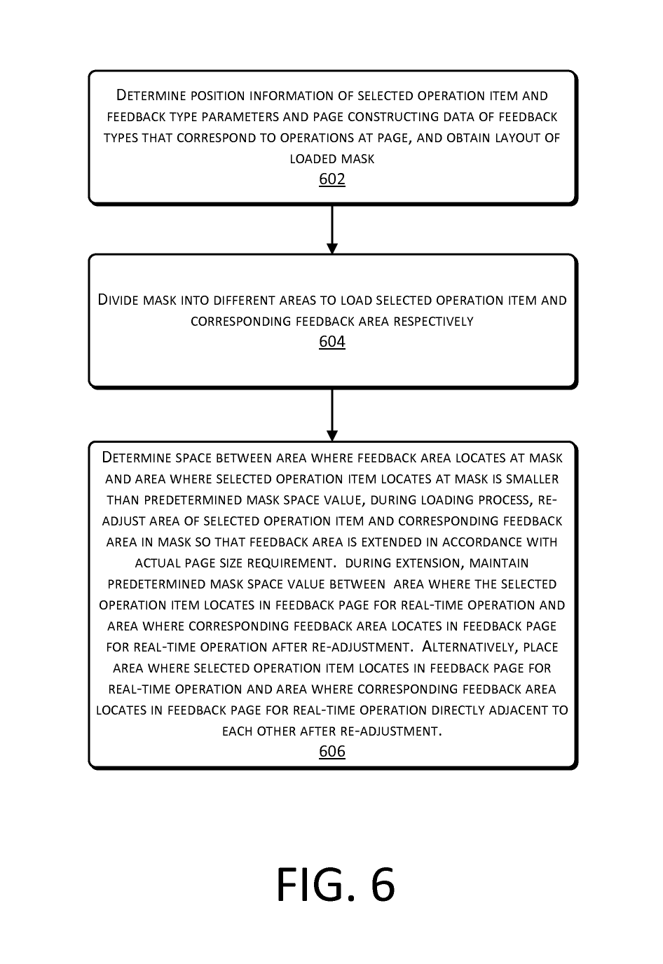

The following example embodiment describes how the layout of the mask is processed. FIG. 3 illustrates an example where an initial layout is a successful layout. FIG. 6 illustrates another example where the initial layout is not reasonable and needs to be re-adjusted.

FIG. 3 is a flowchart illustrating loading the mask according to the second example embodiment of the present disclosure.

At 302, the position information of the selected operation item and the feedback type parameters and the page constructing data of the feedback types that correspond to various operations at the page are determined and a layout of the loaded mask is obtained.

For example, the feedback type parameters and the page constructing data of the feedback types that correspond to various operations at the page may be automatically determined according to the feedback types that correspond to the various operations at the page. As describe above, the feedback types that correspond to different operations may correspond to different feedback type parameters and page constructing data. When a feedback type corresponds to a specific operation is selected, its corresponding feedback type parameters and page constructing data are selected.

As the selected operation item and the corresponding feedback area are reloaded at the feedback page for real-time operation, it needs to determine how the selected operation item is re-defined at the feedback page for real-time operation. In other words, the position information of the selected operation item is re-determined. Meanwhile, the feedback area corresponding to the selected operation item needs loading. In other words, when the mask is loaded, the layout of the mask needs to be considered to effectively reload the selected operation item and the corresponding feedback area at the feedback page for real-time operation.

At 304, the mask is divided into different areas to load the selected operation item and the corresponding feedback area respectively.

For example, when the display is presented in a vertical screen manner, the mask may be divided in a top-down direction. The selected operation item may be loaded at least one of the divided areas. Meanwhile, the corresponding feedback area of the selected operation item may be loaded at another area that has certain spaces from the area of the selected operation item. When the display is presented in a horizontal screen manner, the dividing process and the loading of the selected operation item and the feedback area may be performed according to a left to right direction. The details are not described herein.

At 306, when the present techniques determine that a space between the area where the feedback area locates at the mask and the area where the selected operation item locates at the mask is larger than or equal to a predetermined mask space value, the loading process is performed in accordance with an actual area of the feedback area and the selected operation item respectively.

During the process of loading the selected operation item and the corresponding feedback area, when the space between the area where the feedback area locates at the mask and the area where the selected operation item locates at the mask is larger than or equal to the predetermined mask space value, it indicates that the layout of the feedback area in the mask and the layout of the selected operating in the mask are reasonable so that the corresponding contents such as the corresponding sub-operation items or the size of the inputting area of the IME may be fully displayed in the feedback area. In this case, a re-adjustment of the layout is not necessary, and the selected operation item and the corresponding feedback area may be loaded directly in accordance with their actual areas in the mask. Meanwhile, the selected operation item may be highlighted and/or an identification of the feedback area may be loaded to emphasize the logical connection between the selected operation item and the corresponding feedback area.

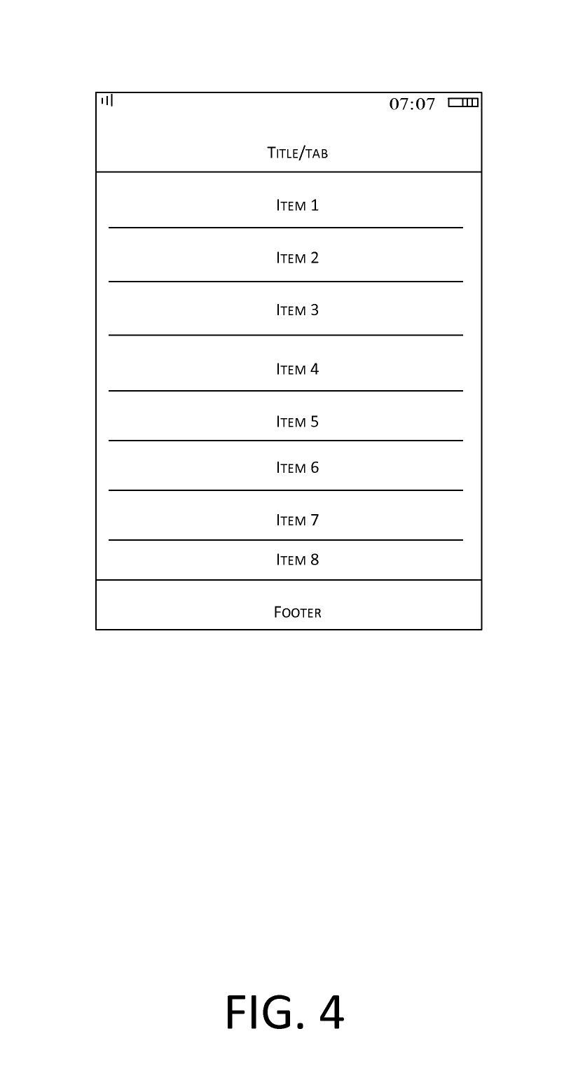

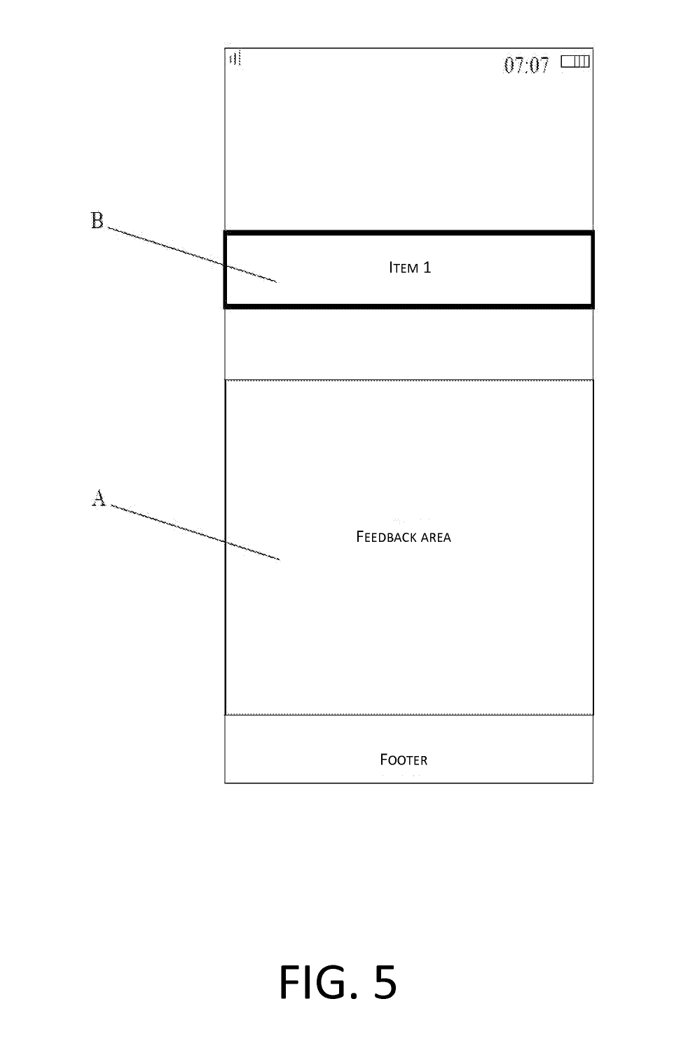

FIG. 4 is a schematic diagram illustrating an example basic operation page. FIG. 5 is a schematic diagram illustrating an example feedback page for real-time operation.

When a triggering operation is operated in a triggering area of item 1 in a page content area for a basic operation, i.e., item 1 is the selected operation item, the selected operation item 1 and the corresponding feedback area need to be reloaded at the corresponding feedback page for real-time operation. As shown in FIG. 5, when it is determined that a space between the area A where the feedback area locates in the mask and the area B where the selected operation item 1 locates in the mask is larger than or equal to the predetermined mask space value, the loading process is performed in accordance with the actual areas of the feedback area and the selected operation item. In a practical implementation, the area where the selected operation item locates at the feedback page for an actual operation or its triggering area, and the triggering area of the feedback area may be processed with different colors to specifically emphasize the logical connection between the operation item and the corresponding feedback page.

FIG. 6 is a flowchart illustrating an example process that loads the mask according to a third example embodiment of the present disclosure.

At 602, the position information of the selected operation item and the feedback type parameters and the page constructing data of the feedback types that correspond to various operations at the page are determined and a layout of the loaded mask is obtained.

At 604, the mask is divided into different areas to load the selected operation item and the corresponding feedback area respectively.

The operations at 602 and 604 may be referenced to FIG. 3 and the details are not described herein.

At 606, when the present techniques determine that the space between the area where the feedback area locates in the mask and the area where the selected operation item locates in the mask is less than the predetermined mask space value, during the loading process, the areas of the selected operation item and the corresponding feedback area in the mask are re-adjusted in an extending direction from the bottom to the top of the effective display area so that the feedback area is extended in accordance with an actual page size requirement.

After 606, during the extension, the present techniques may maintain the predetermined mask space value between the area where the selected operation item locates in the feedback page for real-time operation and the area where the corresponding feedback area locates in the feedback page for real-time operation after the re-adjustment. Alternatively, the area where the selected operation item locates in the feedback page for real-time operation and the area where the corresponding feedback area locates in the feedback page for real-time operation are directly adjacent to each other after the re-adjustment.

Different from the second example embodiment, when the selected operation item and the corresponding feedback area are loaded, if the space between the area where the feedback area locates at the mask and the area where the selected operation item locates at the mask is less than the predetermined mask space value, it indicates that the layout of the feedback area in the mask and the layout of the selected operating in the mask are not reasonable so that the corresponding contents such as the corresponding sub-operation items or the size of the inputting area of the IME cannot be fully displayed in the feedback area. Thus, a re-adjustment of the layout is needed to re-adjust the selected operation item and the corresponding feedback area loaded at the mask.

For example, the re-adjusting process may be performed in accordance with an extending direction from the bottom to the top of the effective display area.

If the space between the area where the selected operation item locates in the feedback page for real-time operation and the area where the corresponding feedback area locates in the feedback page for real-time operation may maintain the predetermined mask space value during the adjusting process, the present techniques maintain the space between the area where the selected operation item locates in the feedback page for real-time operation and the area where the corresponding feedback area locates in the feedback page for real-time operation as the predetermined mask space value. For instance, the loaded mask may have a sufficient area to allow the space between the area where the selected operation item locates in the feedback page for real-time operation and the area where the corresponding feedback area locates in the feedback page for real-time operation to maintain the predetermined mask space value after the re-adjustment.

If the space between the area where the selected operation item locates in the feedback page for real-time operation and the area where the corresponding feedback area locates in the feedback page for real-time operation may not maintain the predetermined mask space value during the adjusting process, and a volume of contents in the feedback area does not exceed the effective display area, the area of the selected operation item may be placed directly adjacent to the corresponding feedback area in the feedback page for real-time operation after the re-adjustment and they may be displayed by different colors.

Specifically, if the space between the area where the selected operation item locates in the feedback page for real-time operation and the area where the corresponding feedback area locates in the feedback page for real-time operation may not maintain the predetermined mask space value during the adjusting process, and the volume of contents in the feedback area does exceed the effective display area, the area of the selected operation item in the feedback page for real-time operation, after the adjustment, may be extended to a top of the effective display area while the corresponding feedback area is placed directly adjacent to the top so that the feedback page for real-time operations occupies the entire effective display area.

FIG. 7 is a schematic diagram illustrating another example feedback page for real-time operation. When a triggering operation is operated in a triggering area of item 7 in a page content area for a basic operating, i.e., item 7 is the selected operation item, the selected operation item 7 and the corresponding feedback area need to be reloaded at the corresponding feedback page for real-time operation. As shown in FIG. 7, when it is determined that a space between the area A where the feedback area locates in the mask and the area B where the selected operation item locates in the mask is less than the predetermined mask space value, and during the re-adjustment the predetermined mask space value cannot be maintained and the volume of contents in the feedback area does exceed the effective display area, the selected operation item and the corresponding feedback area loaded at the mask are re-adjusted during the loading. Different from the feedback page for real-time operation as shown in FIG. 5, the triggering area where the item 7 locates is pushed up to a title area at the top of the page as the feedback area is pushed up while the portion below the title area is the feedback area. Meanwhile, the area of the feedback area and the area of the operation items are directly adjacent to each other.

In the above example embodiments of FIGS. 3 and 6, as a page operation area is defined in the feedback page for real-time operation, generally with respect to a top-down display manner, the feedback area may be defined from an up limit of the page operation area to a top direction. With respect to a left-right display manner, the feedback area may be defined from a right limit of the page operation area to a left direction.

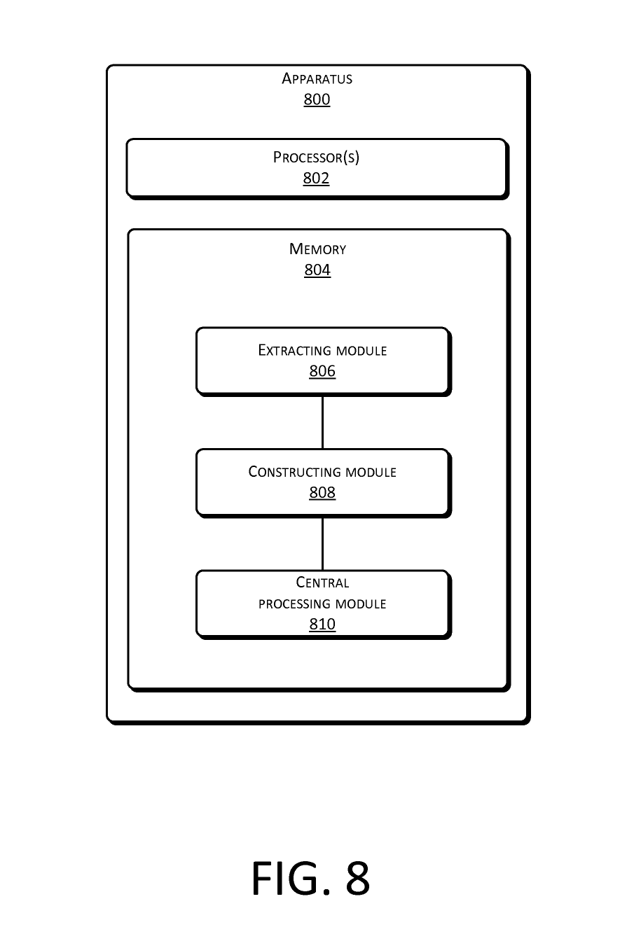

FIG. 8 is a diagram illustrating an example apparatus 800 for feedback in a human-machine interactive operation. The apparatus 800 may include a plurality of modules. Each of the apparatuses may be in the form of software, hardware, or a combination thereof. For example, as shown in FIG. 8, the apparatus 800 may include one or more processor(s) 802 and memory 804. The memory 804 is an example of computer-readable media. As used herein, “computer-readable media” includes computer storage media and communication media. Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 804 may store therein a plurality of modules including an extracting module 806, a constructing module 808, and a central processing module 810.

The extracting module 806 extracts and pre-stores one or more feedback type parameters and page construction data of one or more feedback types that correspond to operations at a page.

The constructing module 808 constructs one or more feedback pages for real-time operation corresponding to different operations at the page by using a same feedback page template in accordance with the feedback type parameters and the page construction data of the feedback types that correspond to the operations at the page.

The central processing module 810 obtains one or more selected operation items at a basic operation page, activates and displays the corresponding feedback page for real-time operation, and reloads one or more selected operation items and their corresponding feedback areas in the feedback pages for real-time operation.

The detailed operations of the extracting module 806, the constructing module 808, and the central processing module 810 may be referenced to contents of the example embodiments as shown in FIGS. 1 and 3. The details are not described herein.

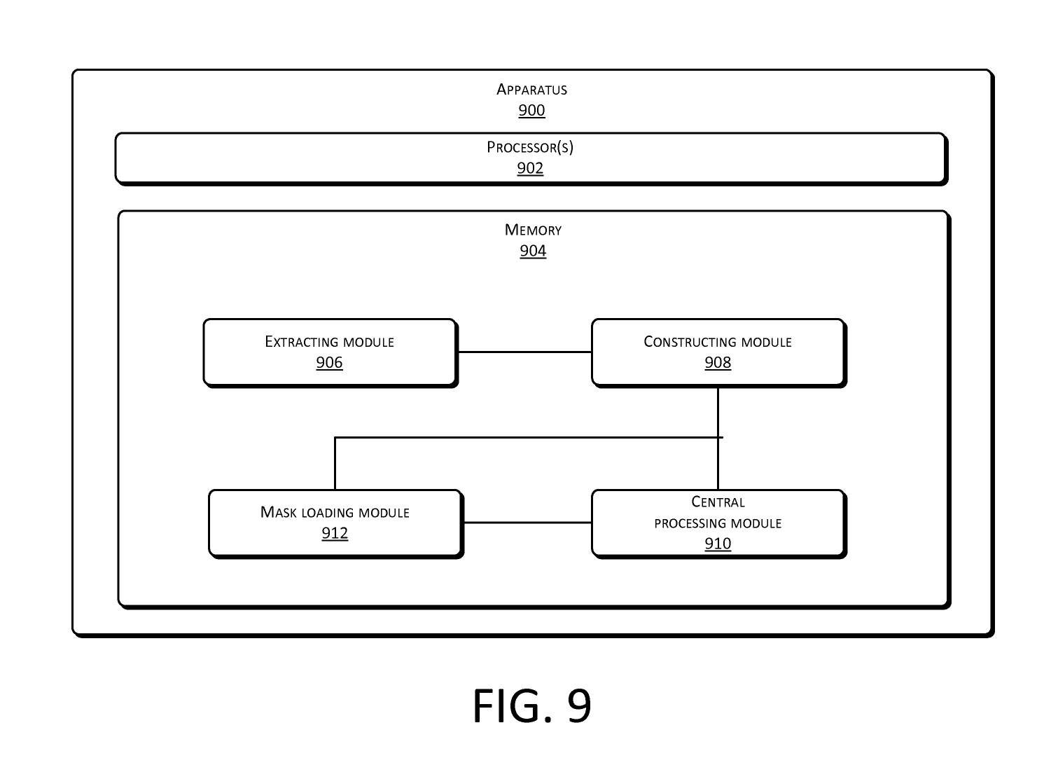

FIG. 9 is a diagram illustrating another example apparatus 900 for feedback in a human-machine interactive operation. The apparatus 900 may include one or more processor(s) 902 and memory 904. The memory 904 may store therein a plurality of modules. In addition to an extracting module 906, a constructing module 908, a central processing module 910, the plurality of modules may also include a mask loading module 912.

The mask loading module 912 loads the mask in the feedback page for real-time operation to reload the selected operation item and the corresponding feedback area to highlight a corresponding relationship between the selected operation item and the corresponding feedback area.

In the example embodiment, the mask loading module 912, when the mask is loaded at the operation page for real-time operation, determines position information of the selected operation item and feedback type parameters and page constructing data of the feedback types that correspond to operations at the page and obtains a layout of the loaded mask. The mask loading module 912 further divides the mask into different areas to load the selected operation item and the corresponding feedback area respectively after the layout of the loaded mask is obtained. When the space between the area where the feedback area locates in the feedback page for real-time operation and the area where the selected operation item locates in the feedback page for real-time operation is larger than or equal to a predetermined mask space, the loading process is performed in accordance with actual areas of the feedback area and the selected operation item. Otherwise the adjustment is performed by re-adjusting the areas of the selected operation item and the corresponding feedback area in the feedback page for real-time operation in an extending direction from bottom to top of the effective display area so that the feedback area may be extend in accordance with actual page size requirement. Thus, after the adjustment, the space between the area where the feedback area locates in the feedback page for real-time operation and the area where the selected operation item locates in the feedback page for real-time operation may maintain the predetermined mask space value. Alternatively, after the adjustment, the area where the feedback area locates in the feedback page for real-time operation and the area where the selected operation item locates in the feedback page for real-time operation may be placed directly adjacent to each other.

The components of the example embodiments may be implemented as hardware, software modules that are executed by one or more processors, or any of the combination thereof. One of an ordinary skill in the art may understand that a microprocessor or a digital signal processor (DSP) may be utilized to implement some or all of the features of some or all of the components according to the above example embodiments of the present disclosure. The present techniques may be further implemented as a part of a device or an apparatus program, or an entire device or apparatus program (such as a computer program or a computer program product). Such programs that implement the present techniques may be stored on computer readable media or may have a format that has one or more signals. Such signals may be downloaded from websites on the Internet, or may be provided via a carrier signal or any other methods.

As used herein, the terms “one example embodiment,” “an example embodiment,” or “one or more example embodiments” indicate that a specific feature, structure or characteristic is incorporated with the embodiment for descriptions including at least one of the example embodiments of the present disclosure. Moreover, it should be noted that the term “in one example embodiment” does not necessarily refer to a same embodiment.

The descriptions provided herein provide a lot of details. However, it is understood that the example embodiments of the present disclosure may be implemented without these details. In some example embodiments, some known methods, structures and technologies are not described in detail in order to avoid obscuring understanding of the descriptions thereof.

It should be noted that the above example embodiments are for the purpose of describing the present disclosure and should not be construed as limitations to the present disclosure, and one person with ordinary skill in the art may design alternative embodiments without departing from the scope of the appended claims. In the following claims, any reference symbol in parentheses should not be construed as limitation to the claims. The term “comprise”, “comprising”, “comprises”, “include”, “including”, and “includes” does not preclude any element or step that is not listed in the claims. The term “a” or “one” before an element does not preclude a plurality of such elements are existed. The present disclosure may be implemented with the assistance of hardware that includes a number of different elements and the assistance of a properly programmed computer. In a claim where a number of apparatuses are listed, some of the apparatuses may be specifically realized by one single hardware item. The terms “first”, “second”, “third” and so on, do not indicate any sequential order. These terms can be interpreted as names of the described subjects.

Furthermore, it should be noted that the wording used in the specification is for the purpose of illustrating and directing the present disclosure, but is not for the purpose of interpreting or limiting the present disclosure. Therefore, it is obvious for a person with ordinary skill in the art that many variations and modifications may be made without departing from the scope and the spirit of the appended claims. The disclosure of the present disclosure is for the purpose of describing but not for the purpose of limiting the scope of the present disclosure, in which its scope is determined by the appended claims.

What is claimed is:

1. A method comprising:
extracting and pre-storing one or more feedback type parameters and page construction data of one or more feedback types that correspond to one or more operations at a page;
constructing one or more feedback pages for real-time operation corresponding to the operations at the page by using a feedback page template in accordance with the feedback type parameters and the page construction data of the feedback types that correspond to the operations at the page;
obtaining a selected operation item at a basic operation page;
activating and displaying a corresponding feedback page for real-time operation; and
reloading the selected operation item and a corresponding feedback area at the corresponding feedback page for real-time operation.

2. The method of claim 1, wherein the activating and displaying the corresponding feedback page for real-time operation comprises displaying the corresponding feedback page for real-time operation in an effective display area by reference to the effective display area of a terminal device and an operation manner that is suitable to operate at the terminal device.

3. The method of claim 2, wherein the operation manner that is suitable to operate at the terminal device comprises popping up the corresponding feedback page for real-time operation from a bottom of the effective display area to a top of the effective display area when the effective area of the terminal device is displayed in a top-down view.

4. The method of claim 1, wherein:
the basic operation page includes a status bar, a page title or navigating area, a page content area, and a page operation area; and
the selected operation item is loaded in the page content area of the basic operation page.

5. The method of claim 1, wherein the reloading the selected operation item and the corresponding feedback area at the corresponding feedback page for real-time operation comprises:
loading a mask in the feedback page for real-time operation; and
indicating a corresponding relationship between the selected operation item and the corresponding feedback area.

6. The method of claim 5, wherein the indicating comprises highlighting the selected operation item through a color adjustment manner.

7. The method of claim 5, wherein the indicating comprises making a color of the selected operation item consistent with that of the corresponding feedback area.

8. The method of claim 5, wherein the loading the mask comprises:
determining position information of the selected operation item, the feedback type parameters and the page constructing data of the feedback types that correspond to the operations at the page; and
obtaining a layout of the mask.

9. The method of claim 8, further comprising dividing the mask into different areas in which the selected operation item and the corresponding feedback area are loaded respectively.

10. The method of claim 1, wherein the reloading comprises:
when a space between an area where the feedback area locates in the feedback page for real-time operation and an area where the selected operation item locates in the feedback page for real-time operation is larger than or equal to a predetermined mask space value, performing loading in accordance with an actual area of the feedback area and the selected operation item respectively.

11. The method of claim 1, wherein the reloading comprises:
when the space between the area where the feedback area locates in the feedback page for real-time operation and the area where the selected operation item locates in the feedback page for real-time operation is less than the predetermined mask space value, re-adjusting the area of the selected operation item and the corresponding feedback area in the feedback page for real-time operation in an extending direction from a bottom to a top of an effective display area so that the feedback area is extended in accordance with an actual page size requirement.

12. The method of claim 11, further comprising maintaining the space between the area where the selected operation item locates in the feedback page for real-time operation and the area where the corresponding feedback area locates in the feedback page for real-time operation as the predetermined mask space value after the re-adjustment.

13. The method of claim 11, further comprising placing the area where the selected operation item locates in the feedback page for real-time operation and the area where the corresponding feedback area locates in the feedback page for real-time operation directly adjacent to each other.

14. The method of claim 1, wherein:
the feedback type parameters of the feedback types that correspond to the operations at the page include a definition of a page frame and a definition of a page content; and
the page constructing data includes a capacity of the page content.

15. The method of claim 1, wherein the feedback types that correspond to the operations at the page may include one of the following or any combinations thereof:
a selecting operation feedback type;
an inputting operation feedback type;
an extending operation feedback type; and
a double confirming operating feedback type.

16. An apparatus comprising:
an extracting module that extracts and pre-stores one or more feedback type parameters and page construction data of one or more feedback types that correspond to one or more operations at a page;
a constructing module that constructs one or more feedback pages for real-time operation corresponding to the operations at the page by using a feedback page template in accordance with the feedback type parameters and the page construction data of the feedback types that correspond to the operations at the page; and
a central processing module that obtains a selected operation item at a basic operation page, activates and displays a corresponding feedback page for real-time operation, and reloads the selected operation item and a corresponding feedback area at the corresponding feedback page for real-time operation.

17. The apparatus of claim 16, further comprising a mask loading module that loads a mask in the feedback page for real-time operation, determines position information of the selected operation item, feedback type parameters and page constructing data of the feedback types that correspond to the operations at the page, and obtains a layout of the mask.

18. The apparatus of claim 17, wherein the mask loading module, after obtaining the layout of the loaded mask, divides the mask into different areas in which the selected operation item and the corresponding feedback area of the selected operation item are loaded respectively.

19. The apparatus of claim 17, wherein the central processing module further displays the corresponding feedback page for real-time operation in an effective display area by reference to the effective display area of a terminal device and an operation manner that is suitable to operate at the terminal device,
wherein the operation manner that is suitable to operate at the terminal device comprises popping up the corresponding feedback page for real-time operation from a bottom of the effective display area to a top of the effective display area when the effective area of the terminal device is displayed in a top-down view.

20. One or more computer storage media stored thereon computer-executable instructions executable by one or more processors to perform operations comprising:
extracting and pre-storing one or more feedback type parameters and page construction data of one or more feedback types that correspond to one or more operations at a page;
constructing one or more feedback pages for real-time operation corresponding to the operations at the page by using a feedback page template in accordance with the feedback type parameters and the page construction data of the feedback types that correspond to the operations at the page;
obtaining a selected operation item at a basic operation page;
activating and displaying a corresponding feedback page for real-time operation; and
reloading the selected operation item and a corresponding feedback area at the corresponding feedback page for real-time operation.
